(19) United States
(12) Patent Application Publication
(10) Pub. No.: US 2008/0184712 A1
(43) Pub. Date: Aug. 7, 2008

(54) Cryopump

(75) Inventor: Ralph C. Longsworth, Allentown, PA (US)

Correspondence Address: KATTEN MUCHIN ROSENMAN LLP, 575 MADISON AVENUE, NEW YORK, NY, 10022-2585, US

(73) Assignees: SUMITOMO HEAVY INDUSTRIES, LTD., Tokyo (JP); SHI-APD CRYOGENICS, INC., Allentown, PA (US)

(21) Appl. No.: 11/721,723

(22) PCT Filed: Feb. 8, 2005
(86) PCT No.: PCT/US05/03844

§ 371 Date: Jun. 14, 2007

(51) Int. Cl. B01D 8/00

(52) U.S. Cl. 62/55.5; 62/268

(57) ABSTRACT

A cryopump cooled by a GM type refrigerator is disclosed in which the cold (second stage) cryopanel(s) are in planes that are pitched parallel to the axis of the expander cylinder; the cold end of the first stage expansion space is close to the point where the expander cylinder enters the vacuum housing that contains the cryopanels; and a drain system removes all the liquid argon and water flowing out through a vent port for two orientations of the cryopump.

### BACKGROUND OF THE INVENTION

The object of the present invention is to provide fast regeneration of a cryopump that is used for sputtering in manufacturing processes such as for the manufacture of semi-conductor wafers. Sputtering typically takes place with a flow of argon at 100 to 200 sccm for a period of about one minute, followed by a cessation of gas flow while the pressure drops to a base pressure of less than 2×10⁻⁷ Torr. Loading of a new wafer occurs in about one minute and the process is repeated.

A throttle plate in front of the cryopump keeps the pressure in the chamber during sputtering at a pressure of about 1×10⁻² Torr while the pressure at the inlet of the cryopump is in the range of 1 to 2×10⁻³ Torr. Since a cryopump removes the gaseous argon by freezing on the second stage (cold) cryopanel, the pump has to be warmed up periodically (regenerated) to melt and remove the argon cryodeposit and then cooled back to normal operating temperatures. Other gases, such as water and hydrogen that accumulate in much smaller quantities, also have to be removed periodically.

Two stage G-M refrigerators, which are presently being used to cool cryopumps, cool a first stage cryopanel at 50 to 100 K and a second stage cryopanel at about 15 K. The expander is usually configured as a stepped cylinder with a valve assembly at the warm end of the first stage, a first stage cold station (at 50 to 100 K) at the transition from the larger diameter first stage to the smaller diameter second stage, and a second stage cold station (at about 15 K) at the far end.

Cryopumps are typically manufactured with the inlet on the axis of the expander cylinder, sometimes called “in line”, or perpendicular to the axis of the cylinder, sometimes called “low profile”. Cryopumps used for sputtering are usually the low profile type because they are more compact when mounted under or on the side of the semi-conductor process chamber.

The most common size cryopump for this application has a 200 mm ID inlet port. The cryopanels for in line cryopumps are typically axi-symetric around the cold finger. This panel design is frequently adapted to low profile cryopumps by having cutouts in the cold panel for the expander cylinder, such as in U.S. Pat. No. 5,156,007. The cryopump operates equally well in all orientations in terms of freezing gases, but during regeneration the melting cryodeposits flow out in different directions depending on the orientation and the design of the cryopump.

U.S. Pat. No. 4,150,549 describes a typical cryopump that uses a two-stage G-M refrigerator to cool two axi-symetric cryopanels. The first stage cools an inlet (warm) panel that pumps Group I gases, e.g. H₂O and CO₂, and blocks a significant amount of radiation from reaching the second stage (cold) panel but allows Group II gases, e.g. Ar and N₂, and Group III gases, e.g. H₂ and He, to pass through it. The Group II gases freeze on the front side of a cup shaped cold panel and Group III gases are adsorbed in an adsorbent on the backside of the cold panel.

U.S. Pat. No. 4,530,213 describes a cold panel design that consists of a series of concentric rings of increasing diameter from the inlet region to the back of the housing. This design is better for sputtering because there is more room for the argon to collect and there is more surface area on which the argon is distributed.

The throughput of semi-conductor wafers depends on a) fast recovery time to base pressure b) maximization of the number of cycles between regenerations and c) fast regeneration consisting of fast warm up, fast removal of the cryodeposits, and fast cooldown.

A number of factors are important in sputtering, starting with fast recovery to base pressure. A base pressure of 2×10⁻⁷ Torr corresponds to a maximum temperature on the surface of the solid argon of 29 K. During the period when argon is flowing, the surface of the solid argon is warmed by the condensing/freezing of the incident gas. Heat is removed from the surface by conduction through the solid argon. When the 2^{nd} stage cryopanel lacks sufficient argon on its surface the surface temperature never warms to 29 K. In this case, recovery time is a function primarily of gas flow patterns from the chamber into the cryopump. However, as the layer of solid argon increases in thickness, the surface becomes warmer and the time it takes to cool the warmest part of the surface back to less than 29 K becomes an important factor.

Having the argon distributed uniformly over a large area minimizes the temperature rise at the surface and reduces the length of the conduction path between the surface and the cryopanel. It is also important to keep the cryopanel temperature below 15 K because the thermal conductivity, k, increases significantly below 20 K and the specific heat, Cp, decreases. Low Cp results in a larger rise in surface temperature while argon is flowing and consequently the temperature difference, dT, between the surface and the cryopanel is higher. A large dT combined with high k results in a faster drop in surface temperature.

In summary, the uniform distribution of solid argon over a large area and panel temperatures below 15 K result in fast pressure recovery.

The ability to maximize the number of cycles between regeneration is another important factor. Because solid argon has a high thermal conductivity, it is possible to have cryodeposits build up to as much as 2 to 3 cm in thickness before pumping speed at a given pressure degrades. For a typical 200 mm ID cryopump, this is equal to about be 1,000 to 1,200 SL of argon. For sputtering applications the capacity is limited by the requirement that recovery to base pressure occurs in less than two minutes, and a capacity of 800 SL is considered to be good.

U.S. Pat. No. 4,530,213 discloses the distribution of the argon cryodeposit on a cryopanel array that has a good configuration for holding a significant quantity of argon. U.S. Pat. No. 6,155,059 is another example of a configuration that is designed to hold significant quantities of solid argon.

Both of these designs provide significant room for the cryodeposit to accumulate. U.S. Pat. No. 5,301,511, on the other hand, has an argon frost concentrating arrangement that is intended to keep significant room open for H₂ to be pumped. Concentrating the argon causes a faster build up of a thick layer and longer recovery time.

A third factor is fast regeneration. Warming the cryopanels can be done either with heaters on the expander heat stations, a blanket heater on the outside of the vacuum housing, or by reverse operation of the expander as described in U.S. Pat. No. 5,361,588. The last option eliminates the need for heaters and simplifies construction. Argon melts at 83 K but the surface only has to reach 42 K before the thermal conduction through the gas between the housing and the cryodeposit becomes a significant source of heat to help melt the solid argon. The presence of H₂, which is typically pumped along with the argon during sputtering, contributes significantly to conduction heating through the gas.

1,000 SL of argon weighs 1.63 kg. This amount of solid argon at 20 K has a volume of about 1 L, requires about 45 kJ of heat to melt, and about 263 kJ more to vaporize. Draining the liquid argon from the pump reduces the time required to remove it. Means of removing the liquid argon are described in U.S. Pat. No. 5,228,299, U.S. Pat. No. 5,333,466, U.S. Pat. No. 5,400,604, U.S. Pat. No. 5,465,584, and U.S. Pat. No. 5,542,257 for pumps in different orientations.

The cryopump can be warmed up to a temperature of about 180 K to remove only the argon and H₂ or it can be warmed to above 300 K to remove all of the gases that have been pumped. In either case warm up is relatively fast because the heat that is input through heaters or reverse operation is augmented by conducted heat and purge gas heating. Some time is then needed to desorb residual gases that have been adsorbed, typically in the charcoal. Typical times are 25 minutes to warm to 320 K, 30 minutes to desorb gases (water) from the charcoal, followed by about 80 minutes to cool back to below 20 K.

U.S. Pat. No. 5,056,319 shows the extension to the first stage heat station that is typical when an axisymetric second stage cryopanel is attached to the second stage heat station in the middle of the housing of a low profile cryopump. U.S. Pat. No. 5,156,007 shows a shield that has to be added over the second stage cylinder to avoid having argon freeze at some temperature above the cryopanel temperature.

Reducing the time to cool down is one of the objects of this invention. It is accomplished by minimizing the mass of material to be cooled, most importantly the first stage heat station.

It is an object of the present invention to maximize the cryodeposit accumulation space and to achieve fast pressure recovery by distributing the cryodeposit uniformly over a large surface that is kept at a temperature below 15 K.

### SUMMARY OF THE INVENTION

Reducing the time to cool down is accomplished by minimizing the mass of material to be cooled, most importantly the first stage heat station. Cryodeposit accumulation space is maximized. In combination, both these factors increase the number of cycles after which regeneration becomes necessary.

The present invention applies to cryopumps having two-stage GM type refrigerators in which the inlet port to the vacuum chamber is in a plane that is parallel to the axis of the expander cylinder. It is generally designed to maximize the throughput of semiconductor wafers in the sputtering process. Cryopumps having a 200 mm inlet port are typically used for this process.

The invention has three essential features. First, the cold (second stage) cryopanel(s) are in planes that are pitched parallel to the axis of the expander cylinder, (a line can be drawn on a cryopanel surface that is parallel to the axis of the expander cylinder). Second, the cold end of the first stage expansion space is close to the point where the expander cylinder enters the vacuum housing that contains the cryopanels, thus minimizing the weight of the first stage heat station. Third, a drain system results in all of the liquid argon and water flowing out through a vent port for two orientations of the cryopump.

This arrangement allows a large volume for solid argon to collect fairly uniformly over cryopanels that have a relatively large surface area. More argon can collect and still meet recovery time requirements than is possible with conventional designs. Liquid is drained directly during warm-up. The cryopanel geometry is such that the drain works with the pump in either of two orientations. The second stage heat station does not have to be in the middle of the housing because the folded cryopanel can be attached any place along its length. The panel extends over the second stage cylinder and obviates the need for a separate shield. These features allow more Ar to collect before regeneration is required, time to warm up during regeneration is minimized, and cool down time is minimized.

### BRIEF DESCRIPTION OF THE DRAWINGS

FIG. 1 is a cross section of a side view of a cryopump showing the main features of the present invention. The expander drive mechanism is not shown in FIG. 1 but can be seen in U.S. Pat. No. 5,361,588.

FIG. 2 is a cross section end view along the centerline of the cryopump housing shown in FIG. 1.

FIG. 3 is a top view of the inlet of the cryopump, with the 1^{st} stage louver removed, so that the 2 stage panels of FIG. 1 are seen.

### DETAILED DESCRIPTION OF THE INVENTION

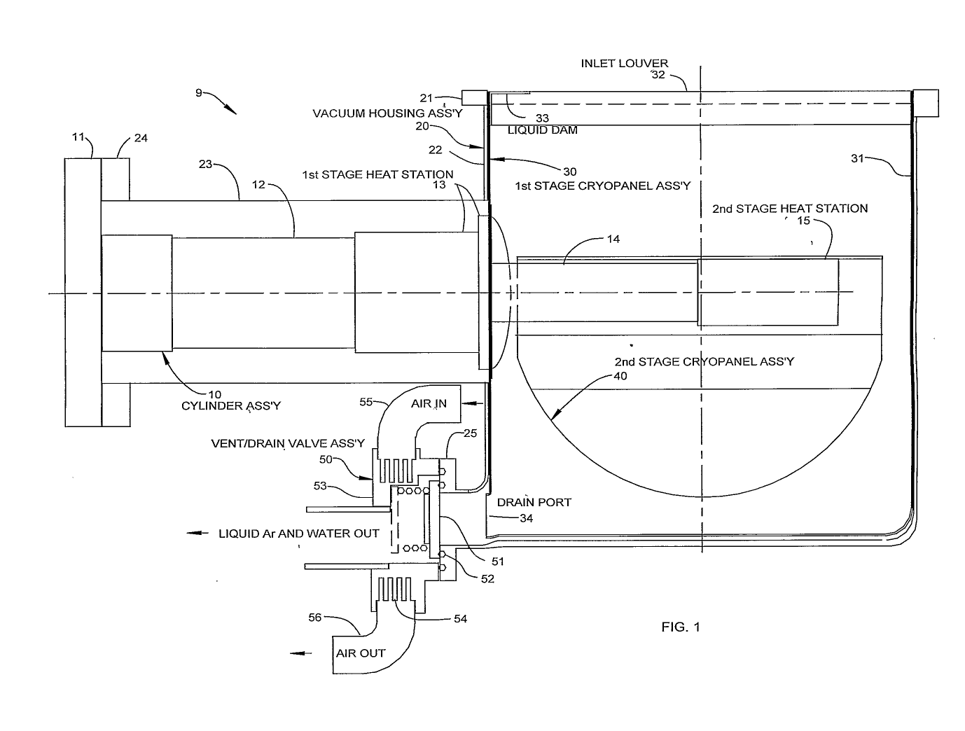

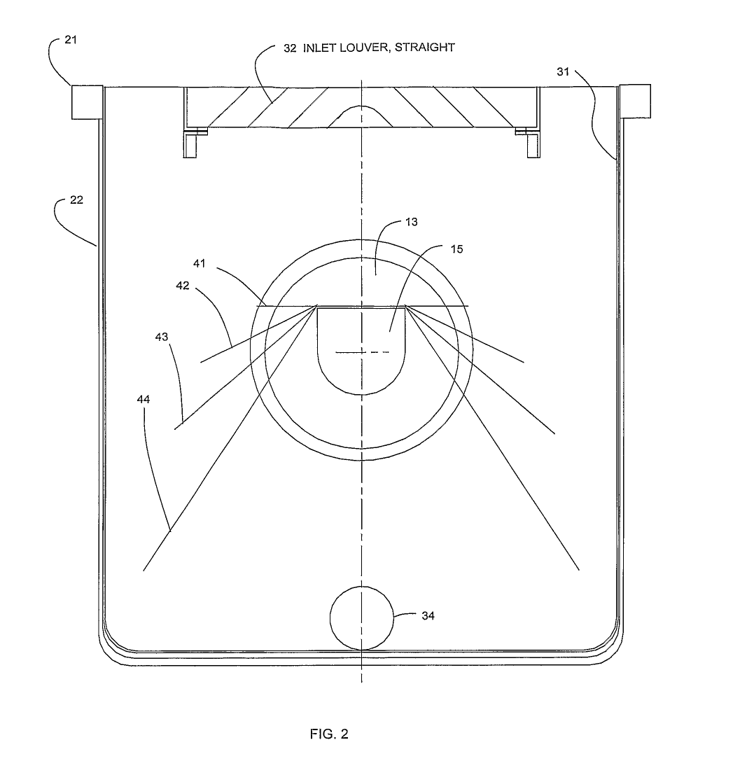

The side view cross section of cryopump assembly 9 shown in FIG. 1 shows the main components including expander cylinder assembly 10, vacuum housing assembly 20, 1^{st} stage cryopanel assembly 30, 2^{nd} stage cryopanel assembly 40, and vent/drain valve assembly 50. Expander cylinder assembly 10 consists of warm flange 11, 1^{st} stage cylinder 12, 1^{st} stage heat station 13, 2^{nd} stage cylinder 14, and 2^{nd} stage heat station 15. Vacuum housing assembly 20 consists of inlet mounting flange 21, cryopanel housing 22, cylinder housing 23, expander mounting flange 24, and vent/drain port 25. Not shown are mounting ports on cylinder housing 23 that are generally standard for cryopumps to mount a pressure gauge, temperature sensors, purge gas input, and possibly heaters. The 1st stage cryopanel assembly 30 consists of radiation shield 31 (frequently referred to as the warm panel), inlet louver 32, liquid dam 33, and drain port 34. The 2^{nd} stage cryopanel assembly 40 (cold panel) consists of cryopanels 41, 42, 43, etc. which are shown in FIG. 2. The pump can be mounted either as shown with inlet mounting flange 21 on top, or vertically with 1^{st} stage cylinder 12 oriented below cryopanel housing 22. Vent valve assembly 50 consists of spring-loaded relief valve 51, “O” ring seal 52, valve body 53 with fins 54 machined in it, upper chimney 55, and lower chimney 56.

The end view cross section, along the centerline of the cryopump housing shown in FIG. 1, is shown in FIG. 2. The flat and folded nature of 2^{nd} stage cryopanels 41, 42, 43, etc. are shown. Second stage heat station 15 has a flat on one side to provide a large surface for attaching 2^{nd} stage cryopanel assembly 40. Inlet louver 32 runs straight across the pump inlet port in line with 2^{nd} stage cryopanel assembly 40. It generally shields the central part of assembly 40 from radiation. The design helps to distribute the argon so it freezes uniformly on the surfaces of the 2^{nd} stage cryopanels. A lot of space is available for solid argon to accumulate. The backsides of the 2^{nd} stage cryopanels are coated with charcoal to adsorb H₂. Vent/drain port 34 is also shown.

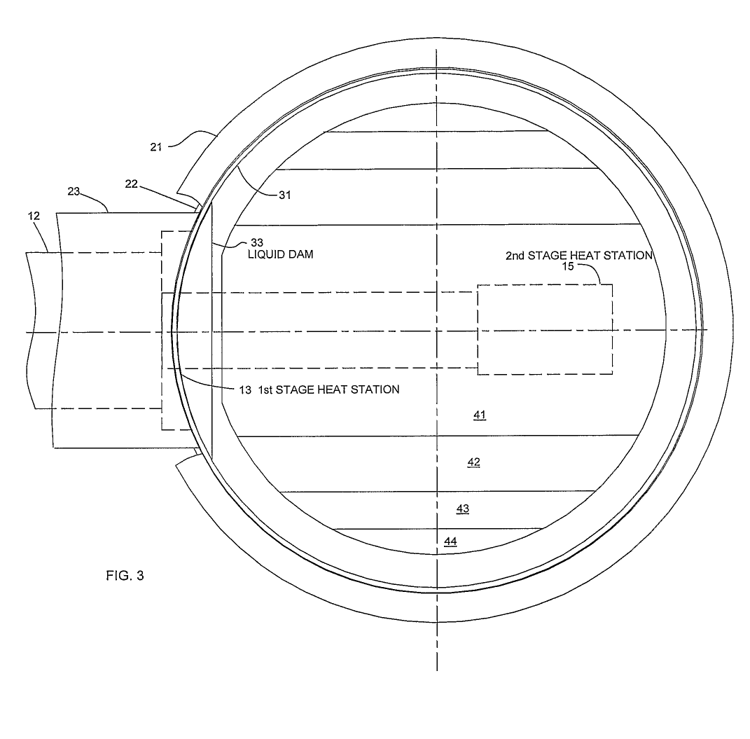

FIG. 3 shows 2^{nd} stage cryopanel assembly 40 looking into the inlet of the cryopump with the 1^{st} stage louver 32 removed. Clearance is left between radiation shield 31 and cryopanels 41, 42, 43, etc. so that H₂ can flow around the panels to get to the charcoal. This view also shows liquid dam 33 that prevents liquid from flowing out of the inlet when the pump is mounted vertically. First stage heat station 13 is curved so that liquid can flow around 2^{nd} stage cylinder 14 when the pump is oriented vertically. Radiation shield 31 is also mounted to heat station 13 so that liquid cannot flow through openings into the region between 1^{st} stage cylinder 12 and cylinder housing 23 when the pump is mounted vertically.

With reference to FIG. 1 it is seen that liquid dam 33 is in front of inlet louver 32, so water that melts when the cryopump is oriented vertically is prevented from flowing out the cryopump inlet and flows out through drain port 34. When liquid Ar flows out through vent valve assembly 50 during regeneration it cools “O” ring 52 to such a rigid condition that it is not capable of resealing when a vacuum is pulled on the cryopump. During warm-up it is customary to have purge gas flowing to remove flammable and toxic gases that might be released. This continues to flow after the liquid argon has been vented but the time available for “O” ring 52 to warm up enough to be compliant is short for fast regeneration cycles.

U.S. Pat. No. 5,542,257 shows a heater on the vent valve to accelerate warming of the seal. The present valve design shows a passive way of accomplishing fast warm up of the seal. Valve body 53 is made of aluminum, which has a high thermal conductivity, and has fins 54 machined into it. Flow of ambient air through the fins is promoted by natural convection, which is enhanced by the connections to upper and lower chimneys 55 and 56. Lower chimney 56 has cold air in it that is denser than the ambient air. A driving force for air to flow through the fins that is proportional to the density difference and the length of lower chimney 56 promotes more airflow through the fins than if the chimneys were removed. The arrangement of the chimneys is such that there is a driving force for both the horizontal orientation shown or the vertical orientation.

FIGS. 1, 2, and 3 show a relatively small gap between radiation shield 31 and cryopanel housing 22. A small gap helps conduct heat from the housing to the radiation shield during warm-up. U.S. Pat. No. 4,449,373 describes using a barrier at the inlet end of the gap and one or more openings at the bottom of the radiation shield to facilitate keeping the pressure in the gap low enough during sputtering so that heat conduction from housing 22 to radiation shield 31 is very small. In the present design, drain port 34 provides the opening necessary to pump gas from the gap.

TABLE 1 is a compilation of the properties of solid Ar that help to explain the earlier discussion of factors that effect the recovery time of the cryopump during the Ar sputtering process. Increasing thermal conductivity and decreasing specific heat, Cp, as the temperature is reduced toward 10 K and the saturation temperature-pressure relation at the surface of the solid Ar are to be noted. It has been observed that the pressure that is measured at the cryopump inlet is a function of the highest surface temperature. To achieve fast recovery it is important to keep the cryopanel temperature below 15 K and distribute the solid Ar uniformly over a large area.

TABLE 1
Properties of Solid Argon

| | Thermal | | |
|---|---|---|---|
| Temperature | Conductivity | Cp | P sat |
| K | mW/cm K | J/g K | Torr |
| 10 | 35 | .09 | |
| 15 | 20 | .20 | |
| 20 | 12 | .29 | |
| 25 | 10 | .38 | 6.8*10⁻¹⁰ |
| 30 | 8 | .45 | 4.5*10⁻⁷ |
| 36 | 7 | .53 | 1.0*10⁻⁴ |
| 42 | 6 | .58 | 5*10⁻³ |

While the cryopump described in this invention is focused on a 200 mm ID pump for sputtering, the basic concepts of flat panels folded over the 2^{nd} stage cylinder of a low profile cryopump, having the first stage heat station end at the cryopanel vacuum housing, and having a liquid drain system that works in both the horizontal and vertical orientations, can be applied to other size housings and other applications.

1. A cryopump cooled by a two-stage GM type refrigerator comprising a housing defining a vacuum chamber, a first stage cryopanel and at least one second stage cryopanel located in the housing and an inlet port to the vacuum chamber from the expander cylinder of the refrigerator where the inlet port is located in a plane parallel to the axis of the expander cylinder and where
a] at least one second stage cryopanel is in a plane parallel to the axis of the expander cylinder,
b] the cold end of the first stage expansion space in the vacuum chamber is located close to the point where the expander cylinder enters the vacuum chamber housing containing the cryopanels, and
c] a drain system is configured to remove all the liquid argon and water through a vent port.

2. The refrigerator of claim 1 where the drain system comprises a finned vent valve constructed of a material having high thermal conductivity.

3. The refrigerator of claim 2 where the drain system further comprises an intake manifold and an output manifold for directing air flow over the finned vent valve.

4. A cryopump cooled by a GM type refrigerator having a two-stage expander and an inlet to the vacuum chamber that is perpendicular to the axis of the cylinder of the expander comprising a first stage cryopanel assembly
attached to the first stage heat station of the expander, and
enclosing a second stage cryopanel assembly attached to the second stage of the expander,
where the second stage cryopanel assembly consists of flat plates folded over the second stage cylinder of the expander.

5. A cryopump in accordance with claim 4 including an inlet louver consisting of flat plates centered along the axis of the second stage cylinder.

6. A cryopump in accordance with claim 5 in which the inlet louver is spaced apart from the second stage cryopanel assembly by at least 3 cm.

7. A cryopump in accordance with claim 4 in which the first stage heat station is proximate the junction in the vacuum housing assembly between the cryopanel housing and the cylinder housing.

8. A cryopump in accordance with claim 4 in which the first stage cryopanel assembly and the vacuum housing assembly incorporate a port for liquid to drain.

9. A cryopump in accordance with claim 1 in which the cryopump can be mounted horizontally with the inlet up, or vertically with the expander having the second stage heat station up.

10. A cryopump in a vertical orientation in accordance with claim 9 in which the radiation shield of the first stage cryopanel assembly is mounted to the first stage heat station such that liquid flows around the second stage cylinder and all the liquid flows out through the drain port.

11. In a cryopump cooled by a two stage GM type refrigerator and comprising an expander cylinder assembly, a vacuum housing, 1st stage cryopanel, flat 2nd stage cryopanel, and vent/drain valve where the expander cylinder consists of a warm flange, a 1st stage cylinder, a 1st stage heat station, a 2nd stage cylinder, and a 2nd stage heat station, the improvement wherein the inlet port to the vacuum chamber is in a plane that is parallel to the axis of the expander cylinder assembly.

12. The cryopump of claim 11 where the cold end of the first stage expansion space is close to the point where the expander cylinder enters the vacuum housing that contains the cryopanels.

13. The cryopump of claim 12 further comprising a drain system positioned such that liquid argon and water flow out through a vent port regardless of whether the orientation of the cryopump is vertical or horizontal.

14. The cryopump of claim 13 comprising an inlet louver positioned across a pump inlet port which shields the central portion of the second stage cryopanel.

15. The cryopump of claim 13 comprising a liquid dam positioned such that liquid is prevented from flowing out of the cryopump inlet when the pump is mounted vertically
